(19) United States
(12) Patent Application Publication
(10) Pub. No.: US 2021/0388822 A1
(43) Pub. Date: Dec. 16, 2021

(54) EXTENDABLE PLATFORMS FOR TOWERS

(71) Applicant: ALIMAK GROUP MANAGEMENT AB, STOCKHOLM (SE)

(72) Inventor: Jesús Angel COLOMA CALVO, LA MUELA (ES)

(21) Appl. No.: 17/283,532

(22) PCT Filed: Oct. 8, 2019
(86) PCT No.: PCT/EP2019/077243

§ 371 Date: Apr. 7, 2021

(30) Foreign Application Priority Data
Oct. 9, 2018 (EP) 18382717.9

(51) Int. Cl. F03D 80/80; F03D 13/20; F03D 13/10

(52) U.S. Cl. CPC F03D 80/88; F05B 2240/916; F03D 13/10; F03D 13/20

(57) ABSTRACT

An extendable platform for a tower is provided. The platform comprises: a support frame, wherein the support frame comprises a plurality of radially extending telescopic legs, wherein the support frame further comprises a plurality of transversally extending cross-members for connecting the radially extending telescopic legs. The platform further comprises one or more floor panels.

This application claims the benefit of European Patent Application EP18382717.9 filed Oct. 9, 2018.

The present disclosure relates to extendable and retractable platforms for towers, and particularly wind turbine towers. The present disclosure further relates to methods for mounting such platforms in towers.

### BACKGROUND

Modern wind turbines are commonly used to supply electricity into the electrical grid. Wind turbines generally comprise a rotor mounted on top of a wind turbine tower, the rotor having a rotor hub and a plurality of blades. The rotor is set into rotation under the influence of the wind on the blades. The operation of the generator produces the electricity to be supplied into the electrical grid.

Towers may be constituted by tower sections which are mounted on top of each other. In the case of e.g. wind turbines, a plurality (e.g. three, four or five or more) contiguous stacked tower sections may be welded together and/or joined through flanges (or the like) to form an entire tower. These tower sections may be formed by one or more tower segments coupled together at corresponding edges to form the entire tower section. These tower sections may be preassembled at a factory workshop, e.g. by welding the corresponding edges of the tower segments, or in situ, e.g. by building an internal temporary structure for positioning the tower segments in place and joining them. Tower segments and tower sections may be found in both steel and concrete (wind turbine) towers. Typically at least some of the tower sections may have different cross-sectional shapes and/or different wall thicknesses to accommodate the weight of the rotor at the top of the tower.

In wind turbine applications there is a trend to build increasingly higher towers in order to obtain increased power output from the wind turbine. An increased height results in higher diameters and in some cases in more tower sections. Therefore, more joining operations or joining operations taking a long time are required. Such joining operations may be bolting one flange of one tower section to the following one. The tightening torque of these bolting connections needs to be inspected and tightened periodically.

When maintenance works, e.g. involving inspection and tightening such a bolted connection in a tower are required inside wind turbines, hoists are often used in the form of elevator-like structures where a lift platform or an elevator car for the transportation of people and/or equipment is hoisted up and/or down within the wind turbine tower. Wind turbines are often provided with working platforms arranged at various heights along the height of the tower with the purpose of allowing workers to leave the elevator car and inspect or repair equipment where intended e.g. the above-commented bolted connections.

These platforms are typically permanently built at the top of each of the tower sections. However, because of the varying cross-sectional shapes and wall thicknesses of the tower, a uniquely manufactured platform is often used at each tower section having a different cross-sectional shape and/or wall thickness. Moreover, the arrangement of components on the platforms, and the elevator path along the height of the tower may be different in different wind turbines.

In summary, the conventional platforms have to be tailored to a specific tower diameter and a specific elevator path and may be redesigned whenever a tower shell diameter or wall thickness changes. Thus, each tower design necessitates several platform designs, which adds to overall construction costs and time, inventory requirements, and so forth.

The present disclosure provides examples of systems and methods that at least partially resolve some of the aforementioned disadvantages.

### SUMMARY

In a first aspect, an extendable platform for a tower is provided. The platform comprises: a support frame, wherein the support frame comprises a plurality of radially extending telescopic legs, wherein the support frame further comprises a plurality of transversally extending cross-members for connecting the radially extending telescopic legs. The platform further comprises one or more floor panels.

According to this first aspect, a platform for towers that is configured to be conveniently extended and retracted using a plurality of radially extending telescopic legs and the transversally extending cross-members is provided. The platform may thus be easily adapted to different cross-sectional shapes of the tower i.e. to different inner diameters of the tower and/or different wall thickness of the tower, for performing assembly or maintenance operations in such towers.

In this respect, the platform comprises a simple design created by the combination of only three types of components, namely the support frame, the radially extending telescopic legs and the transversally extending telescopic cross-members. Due to the provision of only three kinds of components, the manufacturing of the platform is improved and simplified. Moreover, the time and cost for producing the platform are reduced.

In a further aspect, a method for mounting a platform in a tower, the method comprising: providing an extendable platform according to the first aspect. A plurality of support elements are provided for supporting and securing the platform. The platform is brought in proximity to the support elements. Then, the platform is extended such that the radial structures of the platform are located at or near the inner surface of the tower. The platform is attached to the inner surface of the tower using the support elements.

According to this aspect, the platform may be shipped and supplied with the radially extending telescopic legs in a substantially retracted position. The logistic for transporting the platform may thus be improved. In this respect, once the platform is transported to the place where the tower is assembled, the platform is extended and attached to the tower.

Even though specific reference is made and the platforms may be specifically adapted to wind turbine towers, similar platforms may be used in other towers as well.

### BRIEF DESCRIPTION OF THE DRAWINGS

FIG. 1 schematically illustrates a view of one example of a wind turbine;

FIG. 2a-2b schematically illustrate an example of a platform in a retracted position and in an extended position according to an example;

FIGS. 3a-3b schematically illustrates the platform shown in FIGS. 2a-2b comprising a floor with floor panels;

FIGS. 4a-4d schematically illustrates another example of a platform comprising a floor with floor panels;

FIG. 5 schematically illustrate another example of a platform in an extended position according to an example;

FIG. 6 schematically illustrate further example of a platform in an extended position according to an example;

FIGS. 7a-7b schematically illustrate an example of a tower of the wind turbine of FIG. 1 comprising a tower section and different ways of attaching a platform as described in previous figures to the tower section;

FIGS. 8a-8b schematically illustrates a longitudinal section view in perspective of a tower of the wind turbine of FIG. 1 and a platform shown in previous FIGS. 2a-2b with a portion of ladder truss and an elevator according to an example;

### DETAILED DESCRIPTION OF EXAMPLES

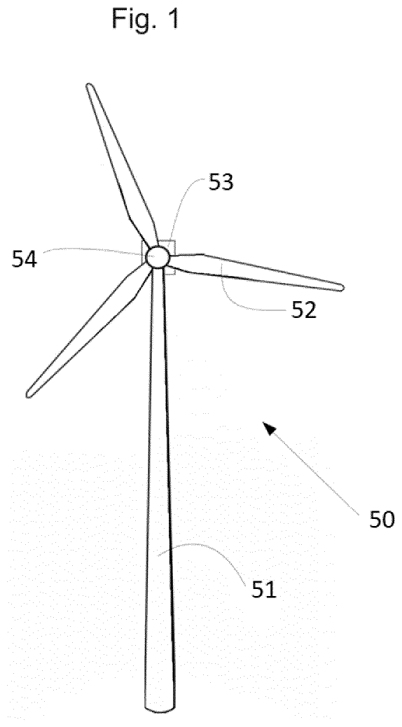

FIG. 1 schematically illustrates a view of one example of a wind turbine 50. As shown, the wind turbine 50 comprises a tower 51, a nacelle 53 mounted on the tower 51, a hub 54 coupled to the nacelle 53 and blades 52 coupled to the hub 54. Inside the nacelle 53 a generator can produce electrical energy as will be apparent to those skilled in the art. Power and communication cables for transmitting electric power and signals from or to the generator may run through the interior of the tower 51.

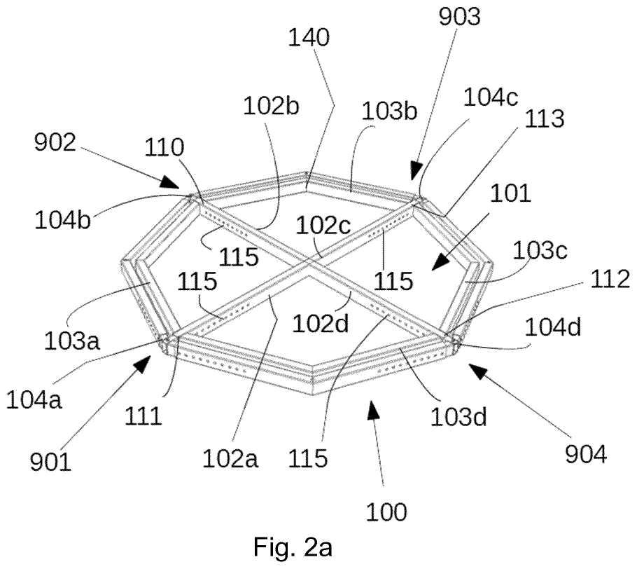

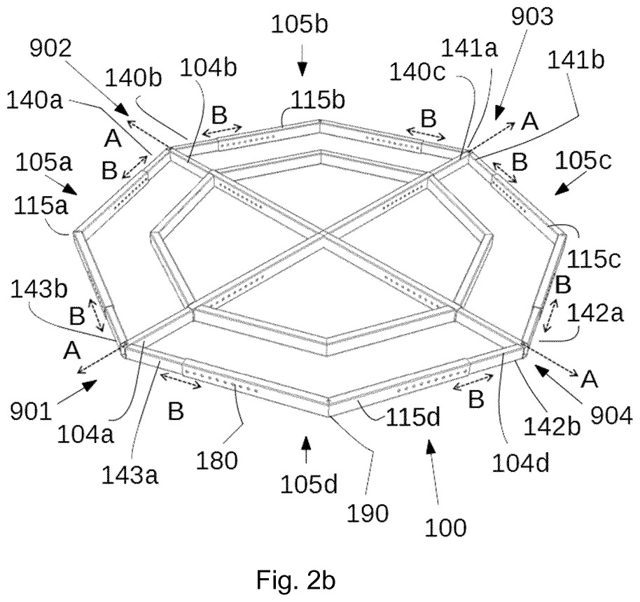

FIG. 2a-2b schematically illustrate an example of a platform 100 in a retracted position and in an extended position according to an example. The platform 100 may be used within the tower 51 of FIG. 1.

As shown in FIG. 2a, the platform 100 comprises a support frame 101. The support frame further comprises four radially extending telescopic legs 901-904. Each of the telescopic legs comprises a radial base member 102a-102d and a corresponding radial extension member 104a-104d. In this particular example, the base members 102a, 102c may be arranged at an angle of 90 degrees with respect to the base members 102b, 102d i.e. the base members 102a, 102c may be arranged substantially perpendicularly with respect to the base members 102b, 102d. Each base member 102a-102d may be a substantially hollow beam comprising a hollow interior space. The base members 102a-102d may comprise e.g. a substantially rectangular cross-section having four connected sidewalls although other cross-sectional shapes are possible e.g. a substantially square cross-section.

The support frame 101 further comprises a plurality of central support beams 103a-103d. Each of the central support beams 103a-103d may be fixedly situated between distal ends of the base members 102a-102d forming part of the telescopic legs 901-904. Particularly, the central support beam 103a may be placed between an end 111 of the base member 102a and an end 110 of the base member 102b. The central support beam 103b may be placed between the end 110 of the base member 102b and an end 113 of the base member 102c. Similarly, the central support beam 103c may be placed between the end 113 of the base member 102c and an end 112 of the base member 102d. Following the example, the central support beam 103d may be placed between the end 112 of the base member 102d and the end 111 of the base member 102a.

Each central support beam 103a-103d may comprise sections separated by a line 140. The sections may define an angle between them. In this example, base members 102a-102d are shown to be fixedly coupled with the central support beams 103a-103d. The central support beams may e.g. be welded to the base members of the telescopic legs.

In this example, each radially extending telescopic legs 901-904 comprises an extension member 104a-104d. The (radially extending) extension members 104a-104d may be slidably disposed inside base members 102a-102d. For example, the extension member 104a may be slidably disposed within the end 111 of the base member 102a. The extension member 104b may be slidably disposed within the end 110 of the base member 102b. Similarly, the extension member 104c may be slidably disposed within the end 113 of the base member 102c. The extension member 104d may be slidably disposed within the end 112 of the base member 102d.

The extension members 104a-104d may be similarly shaped as the corresponding base member 102a-102d. Thus, in the case where a hollow base member 102a-102d comprises a substantially quadrangular cross-section having four connected sidewalls, the corresponding extension members 104a-104d may also comprise a substantially quadrangular cross-section having four connected sidewalls. The sidewalls of the extension members 104a-104d may have external surfaces. The external surfaces of the legs 104a-104d may thus slide and rest against internal surfaces of the sidewalls of the corresponding base members 102a-102d.

The extension members 104a-104d, the base members 102a-102d and the central support beams 103a-103d may be made of any suitable material e.g. steel, aluminum, composites and so forth.

A plurality of apertures 115 may be provided through opposing sidewalls of the base members 102a-102d. A further plurality of apertures (not visible) may be disposed in the corresponding sidewall of the extension members 104a-104d. The apertures may be e.g. substantially circular holes. The extension members 104a-104d may be slid within the corresponding base member 102a-102b to align one aperture in the base member 102a-102b with at least one aperture in the corresponding extension member 104a-104d.

A locking mechanism may be provided to mechanically lock the extension members 104a-104d with respect to the corresponding base member 102a-102d in predetermined positions. For example, a pin (not shown) may be disposed through one of the apertures 115 of the base members 102a-102d and one of the apertures of the corresponding extension members 104a-104d when both apertures are aligned. Throughout the present description and claims, the term “pin” may include any member disposed through the aligned apertures, such as a rod, detent, spring pin, bolt, screw and so forth.

As shown in FIG. 2b, the platform 100 further comprises a plurality of transversally extending telescopic cross-members 105a-105d for connecting, in this example, the distal ends of the extension members of the radially extending telescopic legs.

Each of the telescopic cross-members 105a-105d may comprise a transverse base member 115a-115d and two transverse extension members.

Similarly as the central support beams, each transverse base member 115a-115d of the telescopic cross-members may comprise sections separated by a line 190. The sections may define an angle between them. It is noted that the angle between sections of the transverse base members 115a-115d of the telescopic cross-members and the angle between sections of the central support beams may be the same angle.

Particularly, each transverse base member may be slidably disposed outside distal ends of the two transverse extension members. For example, the transverse base member 115a may be slidably disposed outside, between a transverse extension member 140a and a transverse extension member 143b. The traverse base member 115b may be slidably disposed between the transverse extension member 140b and a transverse extension member 140c. Similarly, the base member 115c may be slidably disposed between a transverse extension member 141b and a transverse extension member 142a. The base member 115d may be slidably disposed between the transverse extension member 143a and the transverse extension member 142b.

A locking mechanism 180 as hereinbefore described may be provided to lock the transverse base members 115a-115d with respect to the corresponding extension members.

Following the example, the radially extending telescopic legs 901-904 (particularly, the extension members 104a-104d of each telescopic leg) may be extended, in the direction of the arrow (arrow A), from a fully collapsed or retracted position shown in FIG. 2a, which in some applications may be approximately 2500 mm, to a fully extended position as shown in FIG. 2b, which may be e.g. approximately 4500 mm. Particularly, the radially extending telescopic legs 901-904 may be extended and/or retracted manually by e.g. an operator. In some other examples, the radially extending legs may include an electric motor configured to extend and/or retract the radially extending telescopic legs 901-904. It is noted that the range between 2500 mm and 4500 mm may fit most inner tower diameters in onshore wind turbine towers.

Moreover, in response of the extension of the radially telescopic legs 901-904 in the direction of the arrow (arrow A), the telescopic cross-members 105a-105d may be extended, in the direction of the arrow (arrow B) from a fully retracted position shown in FIG. 1a to a fully extended position as shown in FIG. 2b.

It is noted that the support frame in the depicted example has an octagonal cross-section although other cross-sectional shapes are possible e.g. a square cross-section, or alternative polygonal cross-sections. It is further noted that the support frame in this example is obtained by the combination of only three types of components, namely the telescopic legs, the telescopic cross-members and the support. The central support beams may have the same size and shape as the base members of the cross-members.

This may further reduce manufacturing complexity and cost.

In summary, the platform 100 includes an assembly that facilitates configuring the platform to mount such platform within different cross-sectional areas of a tower cavity of the tower 51 shown in FIG. 1.

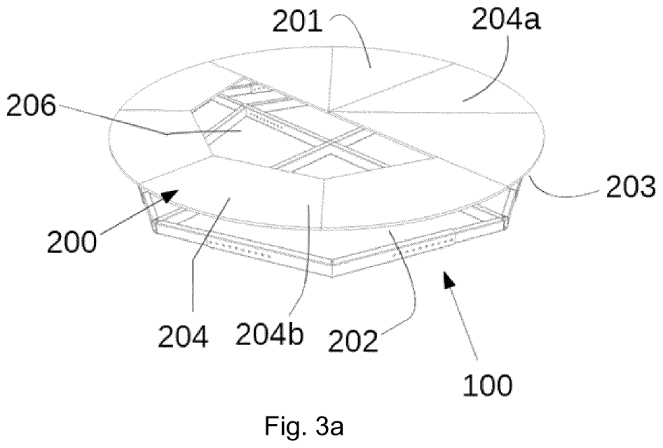

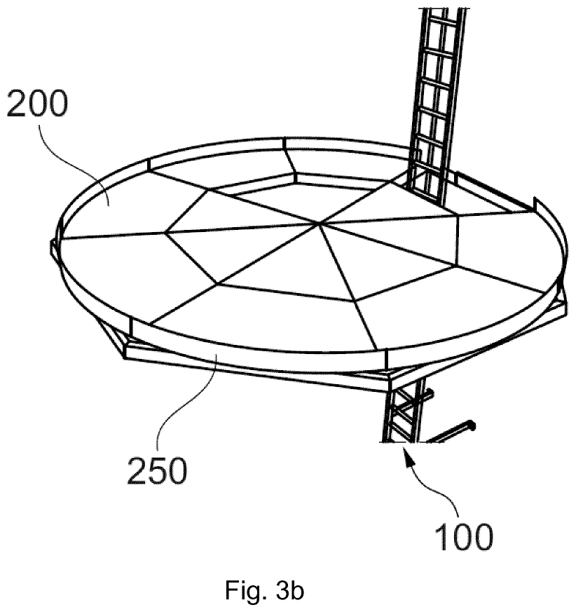

FIG. 3a-3b schematically illustrate the platform 100 shown in FIGS. 1a-1b comprising a floor 200 formed with floor panels. The floor panels may be made e.g. of steel, aluminum, wood or composite materials. As shown in FIG. 3a, the floor 200 includes a top surface 201, a bottom surface (not visible in FIG. 3a) and a perimeter 202. The floor 200 may be fastened to the support frame 101 such that bottom surface (not visible in FIG. 3a) engages the support frame in a mating arrangement. For example, at least one floor fastener (not shown in FIG. 3a) may extend through at least one floor fastener opening and through at least one frame opening to fasten floor 200 to the platform 100.

The floor 200 may be sized to substantially conform to a cross-sectional area of cavity of a tower wherein the platform may be installed. At least a portion of perimeter 200 may thus be substantially adjacent to an inner surface of the tower. The floor 200 may comprise e.g. a generally circular shape.

As commented above, the floor 200 may include a plurality of floor segments 204 including e.g. a plurality of generally triangularly shaped floor segments 204a and a plurality of floor segments 204b with a quadrilateral shape. Alternatively, floor 200 may include a plurality of floor segments having any shape that allows floor to function as described herein.

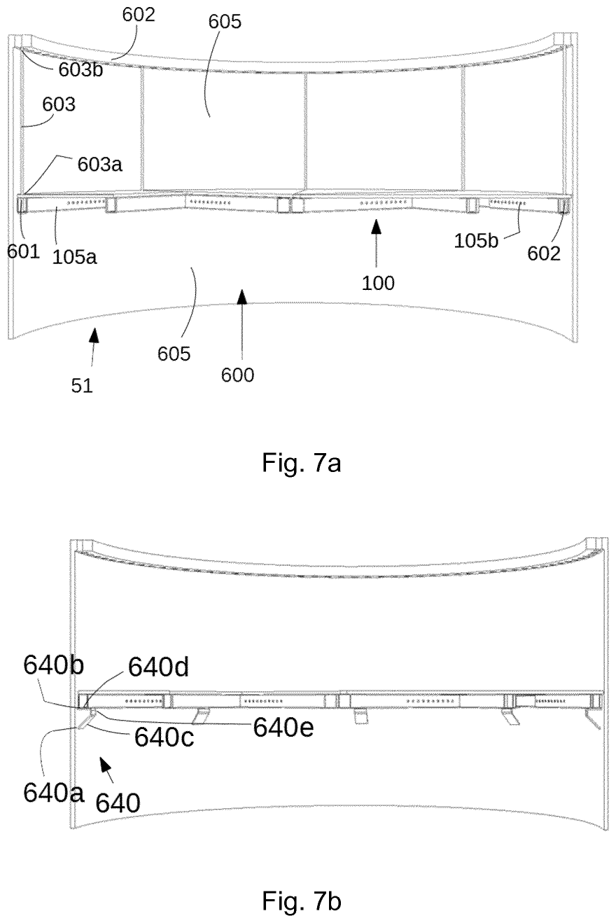

The floor 200 may include one or more access openings 206 extending therethrough, the access opening 206 may permit e.g. human ascent through platform 100 using a ladder or an elevator ascent. An example of a ladder and elevator which may be located in a corresponding access opening is shown in FIGS. 7a-7b.

It is noted that the access opening 206 may be located at any suitable position along the floor 200 simply by removing and/or adding and/or repositioning corresponding floor panels. This way, the access opening may be adapted e.g. to an elevator path or a ladder.

It is further noted that the same or a similar floor panels may be attached to any of the platforms described herein.

Additionally FIG. 3b shows that the platform 100 shown in previous examples may comprise a lateral skirting 250 to prevent tools that could roll on the top surface from falling off. The skirting 250 may also help to adapt the platform to different inner diameters of a wind turbine tower without the need to use many panels of different sizes. The lateral skirting may be e.g. welded to the perimeter.

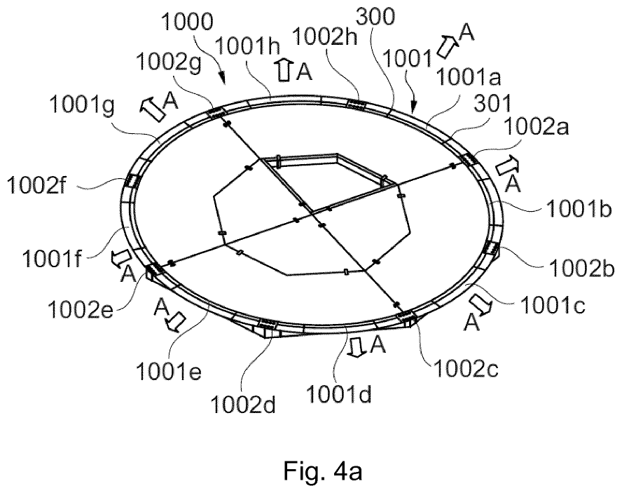

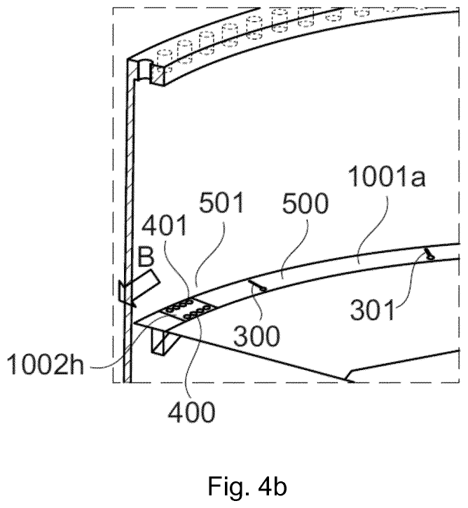

FIGS. 4a-4b schematically illustrate a platform 1000 which may be used within the tower 51 of FIG. 1. The platform 1000 shown in FIGS. 4a-4b differs from the platform 100 shown in FIGS. 3a-3b only in that the platform 1000 comprises a retractable lateral cover 1001. The retractable lateral cover 1001 is configured to cover a gap formed between the platform and the tower. The structure and operation of the remaining components of the platform may substantially be the same or similar as hereinbefore described.

Particularly, the retractable lateral cover 1001 may comprise a plurality of radially extending lateral covers 1001a-1001h e.g. eight radially extending lateral covers. Each of the radially extending lateral covers can be extended independently.

Additionally, each of the radially extending lateral covers 1001a-1001h may comprise two slotted holes. For example, as shown in FIGS. 4a and 4b, the lateral cover 1001a comprises the slotted holes 300, 301. The structure of the remaining lateral covers may substantially be the same.

Each of the radially extending lateral covers may slidably be arranged with respect to the platform via the corresponding slotted holes. Each of the covers may thus slide in the direction of the arrow (arrow A) and rest again an inner surface of tower. As shown in FIG. 4b, by extending the lateral covers, a gap 500 formed between the platform and the inner wall of the tower may be covered by such covers. However, once each of the lateral covers is extended, a further space 501 is still located between the lateral covers.

In this respect, again in FIG. 4a, the cover 1000 may further comprise a plurality of transversally connecting covers 1002a-1002h. The covers 1002a-1002h may be located at distal portions of each of the lateral covers 1001a-1001h. Each of the transversally extending covers 1002a-1002h comprises two slotted holes. For example, as shown in FIG. 4b, the transversally extending cover 1002h comprises two slotted holes 400, 401. The structure of the remaining transversally extending covers may substantially be the same.

Each of the transversally extending covers 1002a-1002h may slidably be arranged with respect to corresponding lateral cover 1001a-1001h via the slotted hole. For example, the cover 1002h may slide in the direction of the arrow (arrow B) and cover the above-commented gap 501 formed between two of the lateral covers, as shown in FIG. 4b. The operation of the remaining transversally extending covers may substantially be the same.

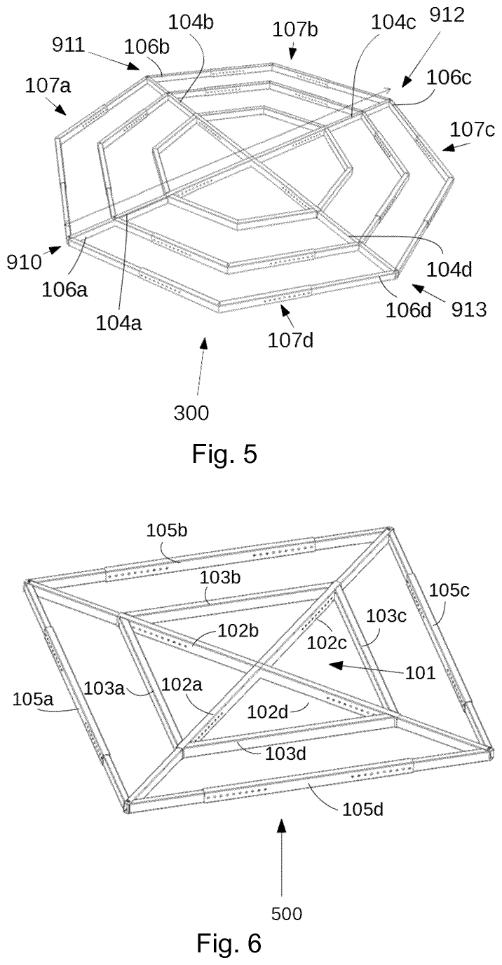

FIG. 5 schematically illustrate another example of a platform in an extended position according to an example. The platform 300 shown in FIG. 4 differs from the platform shown in FIGS. 2a and 2b only in that the telescopic legs 910-913 are double telescopic legs and further telescopic cross-members 107a-107d are provided. The structure and operation of the double telescopic legs 900-903, the cross-members 107a-107d and the remaining components of the platform may substantially be the same or similar as hereinbefore described.

Particularly, the double telescopic legs are similar to the telescopic legs as hereinbefore described but with the provision of further telescopic legs comprising further extension members 106a-106d slidably disposed inside the members 104a-104d acting as base members. For example, the extension member 106a may be slidably disposed within the member 104a. The extension member 106b may be slidably disposed within the member 104b. Similarly, the extension member 106c may be slidably disposed within the member 104c and the extension member 106d may be slidably disposed within the member 104d.

The transversally extending telescopic cross-members 107a-107d may be located at distal portions of the extension members 106a-106d and their operation may be the same as hereinbefore described.

With such an arrangement, the platform may be extended to longer inner tower diameters with respect to the platform shown in previous examples e.g. above 4500 mm.

Evidently, further telescopic legs (including further extension members) and further telescopic cross-members may be added to the platform such that the platform may be suitable to be installed in wind turbine towers comprising even longer inner diameters.

FIG. 6 schematically illustrate a further example of a platform 500 in an extended position according to an example. The platform 500 shown in FIG. 5 differs from the platform shown in FIGS. 2a-2b only in that the central support beams 103a-103d (forming part of the support frame 101) and the transverse base members forming part of the telescopic cross-members 105a-105d are substantially straight and the base members 102a-102d forming part of the telescopic legs are not substantially perpendicular with respect to each other. The operation of the components of the platform may substantially be the same as hereinbefore described.

Particularly in this example, the central frame may have a quadrangular cross-section. Similarly as before, the quadrangular cross-section may be obtained using only three types of components, namely the telescopic legs, the telescopic cross-members and the support.

FIGS. 7a-7b schematically illustrate an example of a tower 51 of the wind turbine of FIG. 1 comprising a tower section and different ways of attaching a platform as described in previous figures to the tower section. The tower 51 in this example may be conical i.e. the diameter increases towards the base. The tower 51 may comprise a first conical tower section 600 (and optionally further conical or non-conical tower section). The first tower section 600 comprises an upper flange 602 and a lower flange (not shown).

The upper flange 602 of the first tower section 600 may be joined to the lower flange of the second tower section (not shown) using bolts or studs. The bolts can be tightened with suitable nuts (not shown), thus fixing the first tower section 600 to the second tower section. Evidently, the other tower sections forming the tower may be attached in the same way.

One way to attach the platform to the tower section is shown in FIG. 6a, a platform 100 as hereinbefore described may be provided. A plurality of through holes 601, 602 may be provided at the cross-members 105a-105d. The holes may be located at the ends of the cross-member and/or at the folding line of the cross-members. Only two 105a, 105b of the cross-members of the platform are shown in this figure.

Each of the holes may be specifically shaped to provide a proper insertion of a first end of an anchoring element 603 e.g. a cable. Particularly, the first end 603a of the cable 603 in question may be inserted through the hole 601 and may be advanced. Once the first end is advanced through the corresponding hole 601, the cable 603 may be coupled to the perimeter part of the platform by any suitable means. The remaining cables may be attached to the corresponding hole in a substantially similar manner.

Moreover, a second end 603b of the anchoring element 603 may be attached to the flanges 602 of the tower section. Alternatively, in an example not shown, the anchoring element may be attached to the inner wall 605 of the tower section 600. The remaining cables may be attached to the flange or the inner wall in a substantially similar manner.

With such an arrangement, a mechanical fixation of the platform 100 to either a flange of the tower section or the inner wall of the tower section may be achieved using the anchoring element. This way, it can be ensured that the platform does not fall down the tower.

A further way to attach the platform to the tower section is shown in FIG. 7b, in this example, a plurality of brackets 640 may be used for mounting and securing the platform. Each of the brackets extends from a first mounting surface to a second mounting surface. For example, the bracket 640 extends from the mounting surface 640a to a second mounting surface 640b. The mounting surface of the brackets may be attached to the inner surface of the tower segment using e.g. screws or bolts.

Moreover, in this example, the bracket comprises a first plate section 640c and second plate section 640d separated by a folding surface 640e. In use, the platform may be situated over the plate section 640d.

In examples more or less brackets may be provided in the inner part of the tower depending on e.g. the weight of the platform.

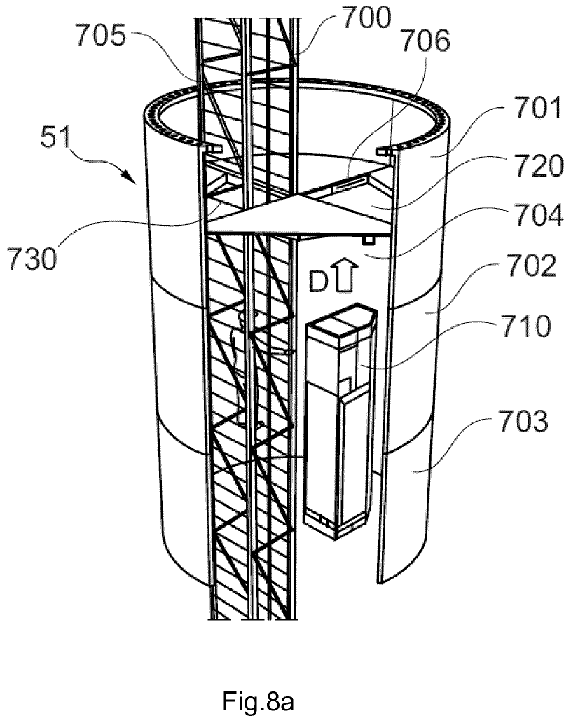

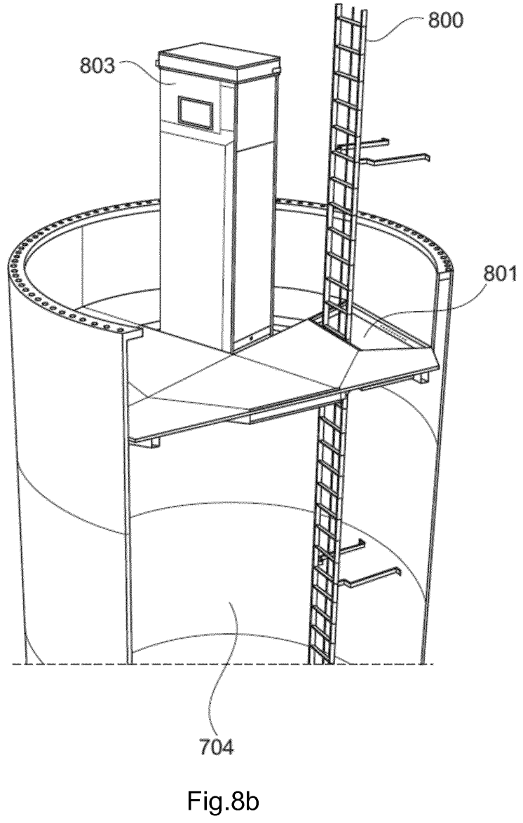

FIGS. 8a-8b schematically illustrates a longitudinal section view in perspective of a tower 51 of the wind turbine of FIG. 1 with a portion of ladder truss and an elevator according to an example. In this respect, an example of mast 700 comprising ladder beams for a tower section 51 is provided. The tower section 51 is made from shell segments 701, 702, 703 on top of each other. As commented above, the tower section 51 may comprise joining flanges disposed at the ends of the tower section. The shell segments may be welded to each other to form the tower section. Moreover, the tower section 51 comprises a platform 706 with floor panels as hereinbefore described. The platform may be positioned in a cavity 704 along the length of the tower section 51. The platform may comprise a ladder opening 730 through which the mast 700 can pass.

The mast 700 comprises a ladder beam 705 and may be connected to the platform 706 in such a way that at least a portion of the mast, in use, hangs from the platform 706. For example, the ladder may be attached to the platform using bolts or a suitable bracket configured to surround, at least partially, the cross section of the ladder. The mast 700 may further be connected to a further flange (not shown) of the tower 51.

In some examples, the platform 706 may be positioned substantially at the top of the tower (section) 51 and the flange (not shown) may be positioned substantially at the bottom of the tower 51.

In some examples, the wind turbine tower 51 may further comprise a service elevator 710. The elevator may follow an elevator path in the direction of the arrow (arrow D) through an elevator opening 720 in the platform as can be seen in FIG. 8a.

FIG. 8b illustrates a further example of a ladder 800 for a tower 51. In this example, the ladder 800 may be attached to the inner wall 704 of the tower 51. Similarly as before, the ladder may be passed through a ladder opening 801.

The structure and operation of the elevator 803 may substantially be the same as hereinbefore described.

It is clear from these examples that by adding/removing some of the panels forming part of the floor, different access openings may be provided such that a ladder or an elevator path may pass through such openings.

For reasons of completeness, various aspects of the present disclosure are set out in the following numbered clauses:

Clause 1. An extendable platform for a tower, the platform comprising:
a support frame, wherein the support frame comprises a plurality of radially extending telescopic legs, wherein the support frame further comprises a plurality of transversally extending telescopic cross-members for connecting the radially extending telescopic legs, and
one or more floor panels.

Clause 2. A platform according to clause 1, wherein the radially extending telescopic legs comprise a base member and an extension member slidably arranged within the base member, wherein the extension member is configured to be selectively extended and retracted within the base member.

Clause 3. A platform according to clause 2, wherein the support frame comprises four or more central support beams, wherein each of the central support beams is configured to be fixedly coupled between distal ends of two of the base members.

Clause 4. A platform according to clause 3, wherein the central support beams are substantially straight.

Clause 5. A platform according to clause 3, wherein each central support beam comprises a first section and a second section, the first and second sections defining an angle between them.

Clause 6. A platform according to any of clauses 2-5, wherein the radially extending telescopic legs comprise a first telescopic portion and a second telescopic portion, wherein the base member of the second telescopic leg is one of the extension members of the first telescopic portion.

Clauses 7. A platform according to any of clauses 1-6, wherein each transversally extending telescopic cross-member comprises a transverse base member and two transverse extension members slidably arranged within the base member, wherein each extension member is configured to be slidably extended from and retracted within the base member.

Clause 8. A platform according to clause 7, wherein the transverse base member is substantially straight.

Clause 9. A platform according to clause 7, wherein the base member comprises a first section and a second section, the first and second sections defining an angle between them.

Clause 10. A platform according to any of clauses 2-9, wherein one or more of the radially extending telescopic legs or telescopic transverse cross-member comprises a locking mechanism configured to lock an extension member with respect to a base member.

Clause 11. A platform according to any of clauses 1-10, wherein the floor panels comprise a perimeter defined around the floor panels and a skirting around the perimeter of the floor segments.

Clause 12. A platform according to clause 11, wherein the perimeter is a substantially circular perimeter.

Clause 13. A tower section comprising one or more extendable platforms according to any of clauses 1-12.

Clause 14. A tower section according to clause 13, wherein the tower section further comprises an inner surface that defines a cavity, the cavity extending along a length of the tower section, the tower section further comprising a plurality of support elements configured to support and secure the platforms to the inner surface of the tower section.

Clause 15. A tower section according to clause 14, wherein each of the support elements is a cable.

Clause 16. A tower section according to clause 15, wherein each of the cables extends from a first end to a second end, wherein the first end of each of the cables is configured to be attached to either an upper connection flange of the tower section or the inner surface of the tower section and the second end is configured to be attached to the platform.

Clause 17. A tower section according to clause 14, wherein each of the support elements is a bracket configured to be attached to the inner surface of the tower such that, in use, the brackets support the platform, and optionally the brackets are welded to the inner surface of the tower.

Clause 18. A wind turbine comprising a nacelle being supported on a vertical tower, wherein the tower comprises one or more tower sections according to any of clauses 13-17.

Clause 19. A method for mounting a platform in a wind turbine tower including one or more tower sections, the method comprising:
providing an extendable platform according to any of clauses 1-12;
providing a plurality of support elements for supporting and securing the platform;
bringing the platform in proximity of the support elements;
extending the platform such that the radial structures of the platform are located at or near the inner surface of the tower;
securing the platform to an inner surface of a section of the tower using the support elements.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples, but should be determined only by a fair reading of the claims that follow.

1. An extendable platform for a tower, the platform comprising:
a support frame, wherein the support frame comprises a plurality of radially extending telescopic legs, wherein the support frame further comprises a plurality of transversally extending telescopic cross-members for connecting the radially extending telescopic legs, and
one or more floor panels.

2. The platform according to claim 1, wherein the radially extending telescopic legs comprise a base member and an extension member slidably arranged within the base member, wherein the extension member is configured to be selectively extended and retracted within the base member.

3. The platform according to claim 2, wherein the support frame comprises four or more central support beams, wherein each of the central support beams is configured to be fixedly coupled between distal ends of two of the base members.

4. The platform according to claim 2, wherein the radially extending telescopic legs comprise a first telescopic portion and a second telescopic portion, wherein the base member of the second telescopic portion is one of the extension members of the first telescopic portion.

5. The platform according to claim 1, wherein each transversally extending telescopic cross-member comprises a transverse base member and two transverse extension members slidably arranged within the base member, wherein each extension member is configured to be slidably extended from and retracted within the base member.

6. The platform according to claim 2, wherein one or more of the radially extending telescopic legs or telescopic transverse cross-member comprises a locking mechanism configured to lock an extension member with respect to a base member.

7. The platform according to claim 1, wherein the floor panels comprise a perimeter defined around the floor panels and a skirting around the perimeter of the floor segments.

8. The platform according to claim 7, wherein the perimeter is a substantially circular perimeter.

9. A tower section comprising one or more extendable platforms according to claim 1.

10. The tower section according to claim 9, wherein the tower section further comprises an inner surface that defines a cavity, the cavity extending along a length of the tower section, the tower section further comprising a plurality of support elements configured to support and secure the platforms to the inner surface of the tower section.

11. The tower section according to claim 10, wherein each of the support elements is a cable.

12. The tower section according to claim 11, wherein each of the cables extends from a first end to a second end, wherein the first end of each of the cables is configured to be attached to either an upper connection flange of the tower section or the inner surface of the tower section and the second end is configured to be attached to the platform.

13. The tower section according to claim 10, wherein each of the support elements is a bracket configured to be attached to the inner surface of the tower such that, in use, the brackets support the platform, and optionally the brackets are welded to the inner surface of the tower.

14. A wind turbine comprising a nacelle being supported on a vertical tower, wherein the tower comprises one or more tower sections according to claim 9.

15. A method for mounting a platform in a wind turbine tower including one or more tower sections, the method comprising:
providing an extendable platform according to claim 1;
providing a plurality of support elements for supporting and securing the platform;
bringing the platform in proximity of the support elements;
extending the platform such that the radial structures of the platform are located at or near the inner surface of the tower;
securing the platform to an inner surface of a section of the tower using the support elements.

16. A wind turbine comprising a nacelle being supported on a vertical tower, wherein the tower comprises one or more tower sections, wherein each tower section comprises one or more extendable platforms, wherein each platform comprises:
a support frame, wherein the support frame comprises a plurality of radially extending telescopic legs, wherein the support frame further comprises a plurality of transversally extending telescopic cross-members for connecting the radially extending telescopic legs, and
one or more floor panels.

17. The wind turbine according to claim 16, wherein the tower sections further comprise an inner surface that defines a cavity, the cavity extending along a length of the tower section, the tower sections further comprising a plurality of support elements configured to support and secure the platforms to the inner surface of the tower sections.

18. The wind turbine according to claim 17, wherein each of the support elements is a cable.

19. The wind turbine according to claim 18, wherein each of the cables extends from a first end to a second end, wherein the first end of each of the cables is configured to be attached to either an upper connection flange of the corresponding tower section or the inner surface of the corresponding tower section and the second end is configured to be attached to the platform.

20. The wind turbine according to claim 17, wherein each of the support elements is a bracket configured to be attached to the inner surface of the tower such that, in use, the brackets support the platform, and optionally the brackets are welded to the inner surface of the tower.
